(19) United States
(12) Patent Application Publication
(10) Pub. No.: US 2013/0092766 A1
(43) Pub. Date: Apr. 18, 2013

(54) DOUBLE BOOM SYSTEM FOR A DRAG HOSE SYSTEM

(71) Applicant: Tom Schottler, Somerset, WI (US)

(72) Inventor: Tom Schottler, Somerset, WI (US)

(21) Appl. No.: 13/651,088

(22) Filed: Oct. 12, 2012

Related U.S. Application Data
(60) Provisional application No. 61/546,390, filed on Oct. 12, 2011.

(51) Int. Cl. B05B 1/20; B23P 17/04

(52) U.S. Cl. 239/748; 29/428

(57) ABSTRACT

A drag hose assembly includes a first pivot point, a first boom, a second pivot point, a second boom, and a fluid flow path. The first boom is pivotally attached to the first pivot point so that the first boom can pivot about the first pivot point, and the second boom is pivotally attached to the second pivot point so that the second boom can pivot about the second pivot point.

### CROSS-REFERENCE TO RELATED APPLICATION

This application claim priority to US provisional application number 61/546,390, entitled DOUBLE BOOM ASSEMBLY FOR A DRAG HOSE SYSTEM and filed Oct. 12, 2011, which is herein incorporated by reference in its entirety.

### TECHNICAL FIELD

The present invention is related to a drag hose system. In particular, the present invention is related to a double boom system.

### BACKGROUND

Wastewater, including liquid and liquid-solid manure, municipal wastewater, and industrial wastewater, is a valuable source of nutrients for agriculture. For example, wastewater is a good resource of nitrogen. For a consistent yield and ascetics, the wastewater preferably is evenly distributed over the land. Because of the high nutrient concentration of wastewater, non-uniform application can result in an unequal growth distribution in the field.

Over the years many different methods and machines have been developed to more efficiently and effectively apply wastewater to land and agricultural fields. In some applications, a tractor pulls a wagon or similar apparatus containing the wastewater for application. In other applications, a tractor is connected to a source of wastewater by a long hose. This type of application is known as a drag hose system.

In a drag hose system, wastewater is pumped from a storage facility or lagoon through a line to a flexible woven hose connected to a tractor. The tractor distributes the wastewater over land. The line and the hose enable land application of the wastewater many miles from the storage site. A drag hose system eliminates transferring the wastewater from a storage facility to a wagon for application, thus, reducing the application time.

Wastewater can be land applied using several different techniques. First, the wastewater can be broadcast on the surface of the soil, and then optionally worked into the soil. Another method includes injecting or knifing the wastewater into the ground. A further method includes mixing the wastewater with the soil during aeration or tillage of the soil. Benefits of drag hose systems include reduced odor, increased availability of nitrogen to the plants, decreased soil compaction, and reduced application time.

Several tractors may be required during the application process. For example, an applicator tractor may be connected to the drag hose, and wastewater may be land applied as the applicator tractor travels across the land. The applicator tractor drags the drag hose as it moves across the land. Such movement may cause the drag hose to roll, kink or be undesirably positioned during the process. A second tractor may be used to reposition the drag hose by scooping or pushing the hose. This is time consuming and increases the risk of abrasion to the drag hose.

### SUMMARY

In certain embodiments, a drag hose assembly includes a first pivot point, a first boom, a second pivot point, a second boom, and a fluid flow path. The first boom is pivotally attached to the first pivot point so that the first boom can pivot about the first pivot point, and the second boom is pivotally attached to the second pivot point so that the second boom can pivot about the second pivot point.

In other embodiments, a method of manufacturing is provided. The method of manufacture mounting a first boom to a platform at a first pivot point and mounting a second boom to the platform at a second pivot point. The platform can be configured to be attached to a farm implement.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 is a perspective view of a drag hose system having a double boom assembly.

FIG. 2 is a simplified cross-sectional view of the drag hose system of FIG. 1.

FIG. 3 is a block diagram illustrating the drag hose system of FIG. 1 from a top view.

FIG. 4A is an enlarged side view of a section of a bottom boom of the drag hose system of FIG. 1.

FIG. 4B is an enlarged top view of the section of the bottom boom of FIG. 4A.

FIG. 5 is a top view illustrating the drag hose system of FIG. 1 in an exemplary use.

FIG. 6 is a top view illustrating a drag hose system having a drawn platform.

FIG. 7 is a top view illustrating a drag hose system in which a first boom assembly and a second boom assembly are connected to horizontally space apart pivot points.

FIG. 8A is a partial side view illustrating the drag hose system of FIG. 7 in which the first boom assembly and the second boom assembly pivot along substantially horizontal planes.

FIG. 8B is a partial side view illustrating the drag hose system of FIG. 7 in which the second boom assembly pivots along a substantially horizontal plane.

FIG. 9 is a top view illustrating an alternative drag hose system.

FIG. 10 is a perspective view of an alternative drag hose system having a double boom assembly.

FIG. 11 is a rear view of an alternative drag hose system.

It is noted that the drawings are not to scale.

### DETAILED DESCRIPTION

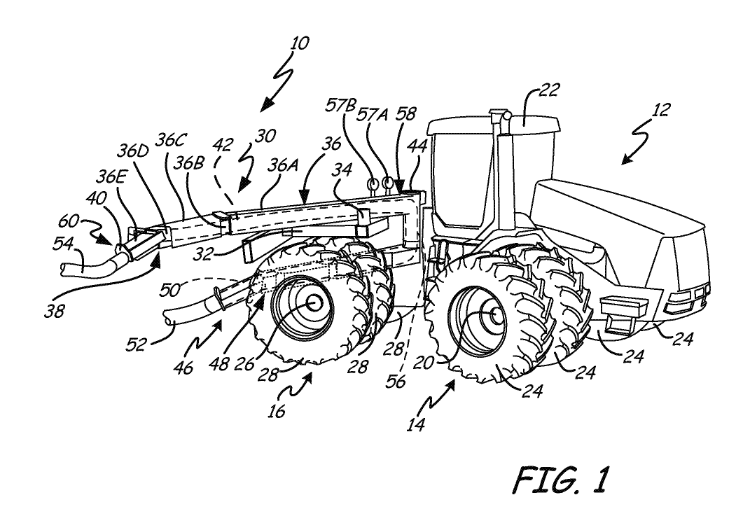

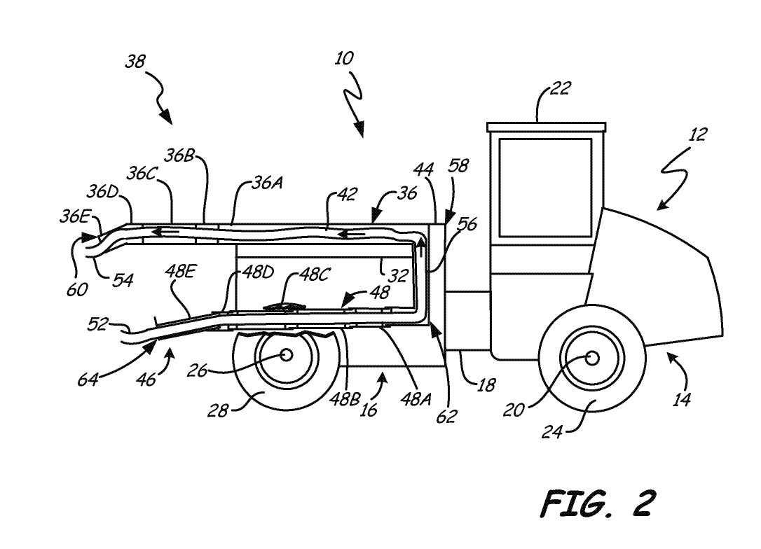

Described herein is a double boom drag hose system that may be attached to a stable platform. The stable platform may be connected to or by be configured to connect to a farm implement. In some embodiments, the platform may be the rear portion of an articulating tractor, the rear portion of a non-articulating, a platform extending from the rear portion of a tractor, or may be towed behind the farm implement. FIG. 1 is a perspective view of drag hose system 10 which includes articulating tractor 12 (having front portion 14, rear portion 16, articulation point 18 (shown in FIG. 2), front axle 20, cab 22, front wheel assemblies 24, rear axle 26, and rear wheel assemblies 28), top boom assembly 30 (which includes frame 32, stops 34, top boom 36, knuckle 38, tow yoke 40, and hose 42), pivot point 44, and bottom boom assembly 46 (which includes bottom boom 48 and hose 50). Drag hose 52 connects to hose 50 of bottom boom assembly 46, and drag hose 54 connects to hose 42 of top boom assembly 30. Connecting line 56 connects hose 42 to hose 50. During use, liquid from drag hose 52 flows through hose 50 to connecting line 56, and then hose 42 before exiting through drag hose 54. As described further below, when drag hose system 10 is a feeder drag hose system, drag hose 54 connects drag hose system 10 to an applicator drag hose system that applies the wastewater to the ground. Although connecting line 56 is illustrated as a hose within a support structure, alternatively, connecting line 56 can be pipe or similar structure in which the support structure provides and defines the internal fluid flow path.

Articulating tractor 12 is a four-wheel drive tractor or quad-trac machine having two halves, front portion 14 and rear portion 16. Suitable commercially available four-wheel drive articulating tractors include STX 375 manufactured by Case New Holland. Front portion 14 and rear portion 16 are joined at articulation point 18 (shown in FIG. 2) so that front portion 14 and rear portion 16 articulate or move relative to one another. Front portion 14 includes front axle 20 and cab 22, which can both be located in front of articulation point 18. Front wheel assemblies 24 mount on front axle 20. Cab 22 provides a sheltered environment for an operator of articulating tractor 12.

Rear portion 16 of articulating tractor 12 includes rear axle 26. Rear axle 26 is located behind or aft of articulation point 18. Rear wheel assemblies 28 mount on rear axle 26. The number and size of rear wheel assemblies 28 can be varied. In one example, rear wheel assemblies 28 include dual tires (i.e., two tires on each side of articulating tractor 12). Because tractor 12 is a four-wheel drive tractor, front axle 20 and rear axle 26 are both driven. In another example, rear wheel assemblies 28 can include tracks. For example, tracks may extend between front wheel assemblies 24 and rear wheel assemblies 28. A farm implement or tractor having tracks is commonly referred to as a track style tractor.

Drag hose system 10 is a double boom system comprising top boom assembly 30 and bottom boom assembly 46. As described further below, drag hose system 10 supports two hoses, drag hose 52 and drag hose 54. Drag hose 52 and drag hose 54 can be flexible woven hoses which are towed or dragged across the ground during land application of wastewater.

Top boom assembly 30 and bottom boom assembly 46 can mount on rear portion 16 of articulating tractor 12, and can connect to pivot point 44. In use, top boom 36 and bottom boom 48 independently pivot about pivot point 44. A flow path is formed through top boom 36 and bottom boom 48. Hoses 42 and 50 extend the length of top boom 36 and bottom boom 48, respectively, and are connected by connecting line 56. In use, wastewater provided through drag hose 52 can flow through hose 50 of bottom boom assembly 46, connecting line 56, and then hose 42 of top boom assembly 30. Hose 42 is connected to drag hose 54 and the wastewater from hose 42 leaves drag hose system 10 through drag hose 54.

Tow gauges 57A and 57B may measure the force on drag hose 52 and drag hose 54. Tow gauges 57A and 57B may be particularly important because tractor 12 can pull with more force than drag hose 52 and drag hose 54 can withstand without a noticeable effect on tractor 12. Tow gauges 57A and 57B may also become increasingly beneficial as the flow rates through drag hose 52 and drag hose 54 increase. As the flow rates through a hose, the impact of breaking or rupturing a hose also increases. Tow gauges 57A and 57B enable the force on drag hose 52 and drag hose 54 to be monitored by the operator of drag hose system 10 in order to prevent damage to the hoses. Alternatively, only one of tow gauges 57A and 57B may be present so that force on only one hose is measured and monitored, or no tow gauges may be present.

Top boom assembly 30 includes frame 32 and top boom 36. Frame 32 can mount on rear portion 16 of articulating tractor 12 to support top boom 36. Forward end 58 of top boom 36 connects to pivot point 44. Aft end 60 of top boom 36 connects to drag hose 54 and may include a connector such as tow yoke 40 to connect drag hose 54 to top boom 36. Top boom 36 can pivot about pivot point 44 while sliding or rolling over the top surface of frame 32. Stops 34 can be placed on either side of frame 32 to limit the radial movement of top boom 36.

Top boom 36 can include several segments, such as boom segments 36A, 36B, 36C, 36D, and 36E, which provide vertical and horizontal freedom to top boom 36. Second boom segment 36B, third boom segment 36C, fourth boom segment 36D, and fifth boom segment 36E may form knuckle 38. In one example, boom segments 36A, 36B, 36C and 36D pivot about vertical axes to provide limited degrees of horizontal freedom to top boom 36. For example, boom segments 36A, 36B, 36C, and 36D can pivot about vertical axes to form a gentle curvature in boom 36 along a horizontal plane. In another example, boom segments 36D and 36E pivot about a horizontal axis to provide limited degrees of vertical freedom to top boom 36. Top boom 36 is formed from a durable and solid material such as steel or other metal.

A fluid flow path extends the length of boom 36. For example, boom segments 36A, 36B, 36C, 36D, and 36E can be hollow and hose 42 can extend through the boom segments. Hose 42 connects between connecting line 56 and drag hose 54 and transports wastewater from connecting line 56 through top boom 36 to drag hose 54. Hose 42 may be a flexible hose so that hose 42 conforms to the shape of top boom 36. Boom segments 36A, 36B, 36C and 36D should be configured so that movement of segments 36A, 36B, 36C and 36D does not result in kinking hose 42.

Bottom boom assembly 46, which includes bottom boom 48 and hose 50, can also mount on rear portion 16 of articulating tractor 12. FIG. 2 is a cut-away view of drag hose system 10 in which rear wheel assembly 28 and the rear fender have been removed to more clearly show bottom boom assembly 46. In one example, bottom boom assembly 46 is mounted below frame 32. The position of top boom 36 and bottom boom 48 and a height of hose 52 and/or 50 for connecting to top boom 36 and bottom boom 48, respectively, can be used to effect the center of gravity of drag hose system 10 and in turn allow the transfer of towing forces. For example, the position of top boom 36 and bottom boom 48 and/or the height of hose 52 and/or 50 for connecting to top boom 36 and bottom boom 48, respectively, may allow for an increase transfer of towing forces, increasing the weight on articulating tractor 12 and allowing articulating tractor 12 to exert more drag force on drag hose 52.

Bottom boom assembly 46 includes forward end 62 and aft end 64. Forward end 62 connects to pivot point 44, and aft end 64 connects to drag hose 52. Bottom boom 48 pivots about pivot point 44. The length of bottom boom 48 can be sized so that drag hose 52 clears rear wheel assemblies 28.

Bottom boom 48 can be segmented. For example, bottom boom 48 can include five segments: first boom segment 48A, second boom segment 48B, third boom segment 48C, fourth boom segment 48D, and fifth boom segment 48E. A fluid flow path is formed through boom segments 48A-48E. For example, boom segments 48A-48E can be hollow, and hose 50 can extend through the interior of boom segments 48A-48E. Bottom boom 48 provides sufficient structure to support hose 50 while boom segments 48A-48E provide flexibility, allowing boom 48 to bend at multiple locations. Bottom boom 48 is formed from a durable and solid material such as steel. Bottom boom 48 protects hose 50 from damage by ultra-violet (UV) light as well from other damage such as cuts and abrasions. Although shown with five segments, bottom boom 48 can include any number of segments, and preferably contains two or more segments.

Boom segments 48A-48E provide horizontal and vertical degrees of freedom. For example, boom segments 48A-48E enable hose 50 to form smooth curves and bends. Boom segments 48A-48E also prevent hose 50 from bending too sharply to kink. In one example, a first end of first boom segment 48A connects to pivot point 44 and a second end of first boom segment 48 connects to second boom segment 48B such that first and second boom segments can pivot horizontally about a vertical axis relative to one another. Second boom segment 48B and third boom segment 48C are attached to one another in a similar manner. Further, third boom segment 48C and fourth boom segment 48D are attached to one another in a similar manner. Fourth boom segment 48D and fifth boom segment 48E connect to one another such that the boom segments can vertically pivot relative to one another about a horizontal axis. The length of boom segments 48A-48E and the amount of rotation allowed between each is designed to prevent kinking hose 50. The radius of curvature at which hose 50 kinks depends on the properties of hose 50. Suitable hose 50 includes flexible woven hoses having an inner diameter of between about 4 inches and about 12 inches.

As shown in FIG. 2, top boom 36 and bottom boom 48 connect to pivot point 44 at different vertical locations such that top boom 36 is positioned above bottom boom 48. When top boom 36 and bottom boom 48 rotate about the same axis, top boom 36 and bottom boom 48 may be discussed as connected to the same pivot point. One skilled in the art will recognize that this is equivalent to describing top boom 36 and bottom boom 48 as connected to two separate pivot points in which the vertical axis extending through each pivot point is aligned.

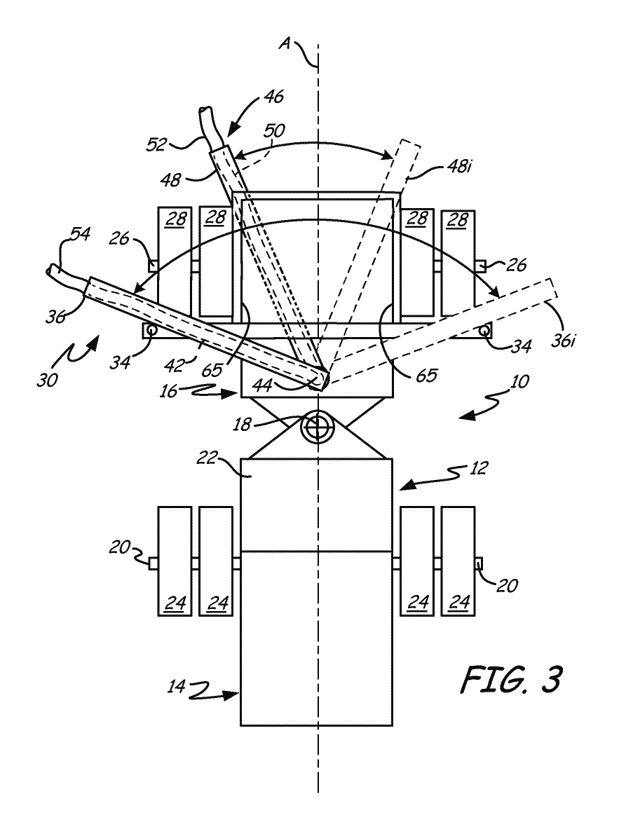

FIG. 3 is a block diagram illustrating drag hose system 10 of FIG. 1 from a top view. Pivoted top boom 36i and pivoted bottom boom 48i are shown in phantom. As discussed above, top boom 36 and bottom boom 48 each connect to and pivot about pivot point 44. Top boom 36 and bottom boom 48 connect to pivot point 44 at vertically spaced apart locations. Top boom 36 and bottom boom 48 are vertically spaced apart to allow adequate vertical clearance between booms 36 and 48 so they do not interfere with the movement of one another. In one example, top boom 36 and bottom boom 48 can each pivot along substantially horizontal planes about the same substantially vertical axis. The horizontal planes are vertically spaced apart so that the substantially horizontal plane of bottom boom 48 is below, or closer to the ground, than the substantially horizontal plane of top boom 36. In one example, the substantially horizontal planes of top boom 36 and bottom boom 48 are vertically spaced at least one foot apart.

Pivot point 44 may be located forward of rear axle 26 and between articulation point 18 of articulating tractor 12 and rear axle 26. Such a location increases the ability of tractor 12 to maintain control of drag hose 52 and drag hose 54 during turning. During use, drag hose system 10 may be used as a feeder drag hose system and may generally manage drag hose 54 supplied to an applicator tractor. A feeder drag hose system may move relatively short distances and complete only a few turns compared to the applicator tractor. Thus, the handling of tractor 12 may not be of high importance and in some examples, pivot point 44 may be located behind rear axle 26.

Top boom 36 can be located above the top surface of rear portion 16 of articulating tractor 12 and can be supported by frame 32. Bottom boom 48 can be positioned below top boom 36 and may be positioned slightly above rear axle 26. Rear fenders 65 are positioned inside of rear wheel assemblies 28, and bottom boom 48 may be positioned between rear fenders 65.

The radial movement of top boom 36 and bottom boom 48 can be limited to prevent hoses 52 and 54 from falling within the path of articulating tractor 12. In one example, stops 34 vertically extend from frame 32 to limit the motion of top boom 36. In one example, top boom 36 can pivot at least about 5° from either side of Axis A, for a total rotation of at least about 10°. In another example, stops 34 are positioned to allow top boom 36 to pivot about 70° from either side of Axis A, for a total rotation of about 140°. Stops 34 must be strong enough to stop top boom 36 when top boom 36 is in motion. In one example, stops 34 include an elastomeric material, such as rubber, to soften the interaction or collision between stops 34 and top boom 36.

Stops may also be used to limit the motion of bottom boom 48. In one example, stops are placed on the inside of rear fenders 65 so that drag hose 52 is prevented from falling into the path of rear wheel assemblies 28. In one example, top boom 36 can pivot to a great extent than bottom boom 48. That is, top boom 36 can rotate a greater degree from Axis A than bottom boom 48. In one example, bottom boom 48 is allowed to pivot at least about 5° from either side of Axis A, for a total rotation of at least about 10°.

Top boom 36 and bottom boom 48 enable drag hose 52 and drag hose 54 to be moved independently. More specifically, drag hose 52 and drag hose 54 pivot independently about pivot point 44 and the segmented portions of top boom 36 and bottom boom 48 independently curve to smooth the transition between top boom 36 and drag hose 54 and between bottom boom 48 and drag hose 52. This reduces impediments to the flow through the system, improving the flow rate.

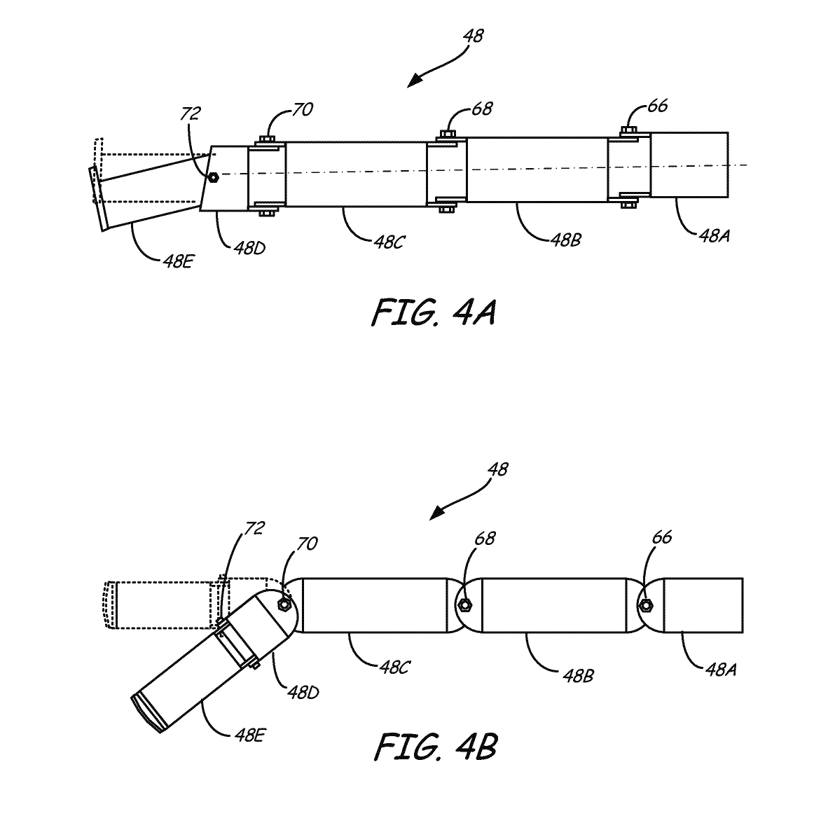

As described above, top boom 36 and bottom boom 48 can include segments which provide additional degrees of vertical and horizontal freedom to the booms. FIGS. 4A is an enlarged side view of bottom boom 48. As shown, first boom segment 48A and second boom segment 48B are joined by fastener 66; second boom segment 48B and third boom segment 48C are joined by fastener 68; third boom segment 48C and fourth boom segment 48D are joined by fastener 70; and fourth boom segment 48D and fifth boom segment 48E are joined by fastener 72. Fasteners 66, 68, 70, and 72 can be any device which fastens two structures together while allowing some degree of rotation. In one example, fasteners 66, 68, 70, and 72 include nuts and bolts.

Bottom boom 48 is configured to permit limited vertical movement of fifth boom segment 48E about a horizontal axis. Pivoted fifth boom segment is shown in phantom in FIG. 4A. As shown, fifth boom segment 48E pivots about fastener 72 in a horizontal direction such that drag hose 52, which is attached to fifth boom segment 48E, moves closer and further away from the ground. In one example, fifth boom segment 48E can pivot about 15° to about 20° from center. That is, fifth boom segment 48E can pivot up to about 15° to about 20° up or down from fourth boom segment 48D. A stop block can be placed under fifth boom segment 48E to prevent further downward movement.

FIG. 4B is an enlarged top view of bottom boom 48 and illustrates that horizontal degrees of freedom of bottom boom 48. As discussed above, first boom segment 48A, second boom segment 48B, third boom segment 48C, and fourth boom segment 48D are connected to one another to enable limited horizontal movement about a vertical axis. Pivoted fourth boom segment 48D is shown in phantom in FIG. 4B. As shown, fourth boom segment 48D can pivot about fastener 70 in a generally horizontal direction. Third boom segment 48C and second boom segment 48B can pivot in a similar manner. Horizontal pivoting enables bottom boom 48 to form gentle curves. The degree of pivoting is controlled to prevent bottom boom 48 from having curves which kink hose 50. In one example, the sides of segments 48A-48D are angled to limit the angle formed between adjacent segments. Although segments 48A-48E are illustrated as having the same size and offset from one another, one or more of segments 48A-48E may alternatively be larger or smaller than the adjacent segment and the smaller segment may be nested inside the larger segment.

The vertical and horizontal flexibility of bottom boom 48 smoothes the transition from drag hose 52 to hose 50 of bottom boom 48. For example, attaching drag hose 52 to bottom boom 48 not having a segmented design results in a sharp angle between drag hose 52 and bottom boom 48, which reduces the wastewater flow rate through drag hose 52 and hose 50. In comparison, the segmented design of bottom boom 48 smoothes the transition such that no sharp angles are present. Instead, the flow path from hose 44 is changed through gentle, gradual angles, resulting in an improved wastewater flow rate. The flexibility and freedom of bottom boom 48 allows the wastewater path to be gradually adjusted to the changing horizontal and vertical orientation of bottom boom 48, such as when bottom boom 48 pivots. By utilizing gradual changes in direction instead of sharp changes, the wastewater flow rate is improved. Bottom boom 48 also prevents kinking or otherwise damaging drag hose 52 and hose 50, which would greatly reduce the wastewater flow rate. Similar benefits between drag hose 54 and top boom 36 are seen when top boom 36 also has a segmented configuration.

The segmented design of top boom 36 and bottom boom 48 provide additional degrees of freedom in the movement of top boom 36 and bottom boom 48. The segmented design may reduce the risk of pulling or ripping the connections between hoses 54 and 52 and hoses 42 and 50, respectively. The pivoting movement of top boom 36 and bottom boom 48 may also reduce the risk of pulling or ripping of the connections between hoses 54 and 52 and hoses 42 and 50 respectively. Similar to the segmented design, the pivoting movement of top boom 36 and bottom boom 48 provide additional degrees of freedom in the movement of top boom 36 and bottom boom 48.

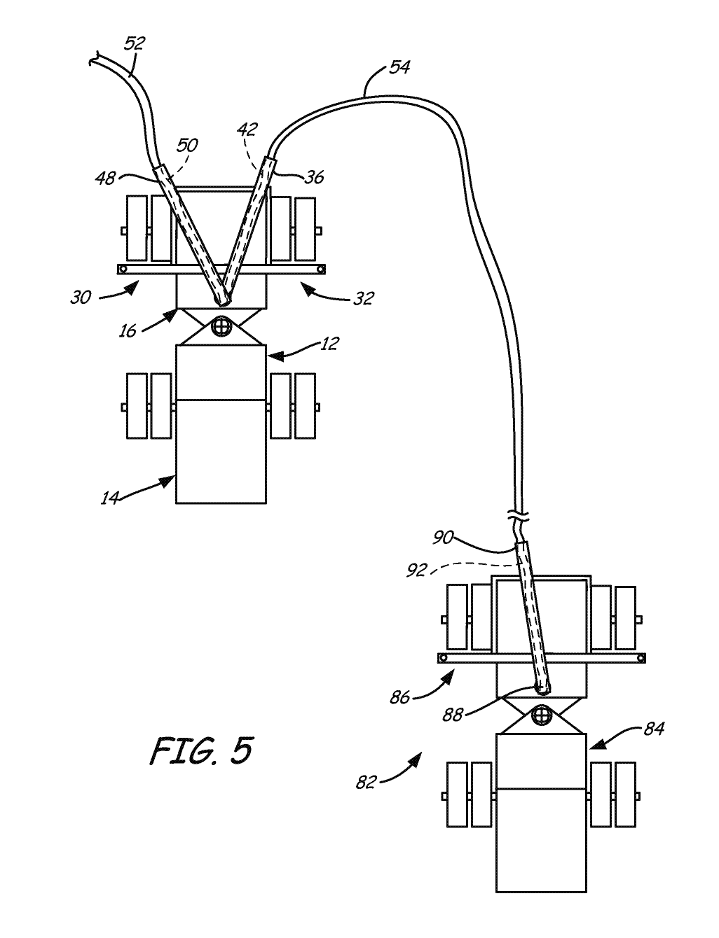

Drag hose system 10 can be used with an applicator tractor to land apply wastewater. FIG. 5 is a top view of example drag hose application system 80 which includes drag hose system 10 and applicator drag hose system 82. Drag hose 54 connects drag hose system 10 to applicator drag hose assembly 82.

Applicator drag hose system 82 includes articulating tractor 84 and applicator boom system 86 (including pivot point 88, boom 90, and interior hose 92). Boom 90 can pivot about pivot point 88 in a manner similar to that described above for top boom 36. Boom 90 can be hollow and formed from a solid, resilient material, such as steel. Interior hose 92 provides a fluid flow path through boom 90 and directs fluid to an applicator (not shown) which applies the fluid (wastewater) to land. For example, articulating tractor 84 may include a splash box for broadcasting the wastewater onto the soil. An opener such as discs may be pulled behind tractor 84 to work the wastewater into the ground. Alternatively, an injector applicator or a drop hose applicator can be used to apply the wastewater. Suitable applicator boom assemblies are described in U.S. Pat. No. 7,975,939, which is incorporated herein by reference in its entirety.

In use, wastewater can be pumped from a storage facility through a line to drag hose 52 and drag hose system 10. As described above, the wastewater flows through hose 50 in bottom boom 48 and then through hose 42 of top boom 36, and exits drag hose system 10 through applicator drag hose 54. The wastewater then travels through applicator drag hose 54 to applicator drag hose system 82.

The line can comprise one or more pipes, tubes or hoses. Suitable pipes, tubes and hoses include but are not limited to mainlines and supply lines. Mainlines can include stationary flexible or non-flexible tubes and hoses. For example, a mainline can be PVC piping which is buried below ground. Supply lines can include movable flexible or non-flexible tubes or hoses, which although movable, are not designed to withstand frequent movement. Example supply lines include above ground aluminum pipes. Mainlines and supply lines are generally not designed to be moved by pulling at one end (i.e., end-pulled). Mainlines and supply lines form permanent or semi-permanent flow paths for directing wastewater from storage facilities. Drag hoses, such as drag hose 52 and drag hose 54, connect between the line and tractors 12 and 84.

Drag hose 52 and drag hose 54 can be flexible woven hoses which are dragged across the ground by one end as tractors 12 and 84 move. The outside of drag hoses 52 and 54 can include an abrasion resistant coating to reduce wear on hoses 52 and 54 from objects on the ground. For example, rocks, crop residue such as corn stocks and bean stubble, and dirt or soil can rub on hoses 52 and 54 causing wear and abrasion and increasing maintenance required on the hoses. Drag hose 52 and drag hose 54 may have the same characteristics and properties. Alternatively, drag hose 54 may be subjected to more handling and movement through the field and may be designed to be more resistant to wear and abrasion. Drag hose 54 may also be designed to maintain better or more consistent curving while being towed back and forth across the field. Drag hose 52 and drag hose 54 may have the same or different diameters. The inner diameters of hoses 52 and 54 depend on several factors such as the wastewater properties and the pumping equipment used. In one example, drag hose 52 and drag hose 54 can have an inner diameter of between about 4 inches and about 12 inches. However, drag hose 52 and drag hose 54 can have any suitable diameter.

Drag hose system 10 may advance drag hose 52 in the field as needed by the applicator drag hose system 82. Drag hose system 10 is connected to applicator drag hose system 82 by drag hose 54. In one example, drag hose 54 is relatively short. The short length of drag hose 54 improves the maneuverability of and the ability to turn corners with tractor 84. The shorter length of hose also improves the ease of land application to small and/or irregularly shaped parcels of land. Such parcels involve multiple turns within short distances of one another, and reducing the amount of hose pulled by tractor 84 increases the ease of turning tractor 84. Additionally drag hose 54 is subjected to a higher degree of wear than the hoses in the system. The relatively short length of drag hose 54 reduces the hose length subjected to high wear.

Drag hose system 10 may improve the ease of land application when obstacles, such as tress, spurs of land, rocks, fence lines, irrigation systems, and swamps, create narrow openings to adjacent parcels of land. In these situations, drag hose system 10 can pull the necessary amount of drag hose 52 through the narrow opening and position it as desired. Once pulled into position, bottom boom 48 remains relatively quiet and maintains control or position of drag hose 52 while top boom 36 allows drag hose 54 to pivot as necessary to support the movement of applicator drag hose system 82.

Drag hose system 10 may improve management of slack in the hose line. The management of slack is particularly notable when land applying to small parcels or spurs. Bringing extra hose (i.e., slack) which may not be needed into a small parcel creates an additional obstacle for applicator drag hose system 82 to avoid and manage. Drag hose system 10 eliminates the need to bring excess slack into a small parcel because drag hose system 10 can easily move forward to provide additional hose length to applicator drag hose system 82 as needed. Thus, preventing excess or undesirable slack from being in the way of applicator system 82.

Drag hose system 10 may reduce twisting and tangling drag hose 52 and drag hose 54. Top boom 36 and bottom boom 48 maintain and control the connection of drag hoses 54 and 52. By connecting to top boom 36 and bottom boom 48, the ends of drag hose 52 and drag hose 54 are maintained spaced apart from one another. This serves to stabilize drag hose 52 and drag hose 54 and prevent rolling of drag hose 52 and drag hose 54 when drag hose 52 and/or drag hose 54 are pulled sideways. This also reduces twisting and tangling of drag hose 52 and drag hose 54, and increases the control with which drag hoses 54 and 52 may be separated or towed if they do twist or tangle with each other. Essentially, enabling a means to first, prevent tangling, and second, enable maneuvering to reverse undesirable twisting or tangling by enhanced control.

Drag hose system 10 may improve tension management on drag hose 54. For example, articulating tractor 12 can move closer to tractor 84 in order to reduce the tension on drag hose 54. Because drag hose system 10 is connected to a tractor, little effort is required to advance additional hose to applicator drag hose system 82. In one example, drag hose 54 is at least 500 feet long. In another example drag hose 54 is at least 660 feet long, at least 800 feet long, and more preferably at least 1,000 feet long. Typical dimensions of fields subjected to the Public Land Survey System are ¼ mile wide by ¼ mile long. Before land was sold or settled, the Public Land Survey System divided land into six mile by six mile townships. The townships were subdivided into one square mile sections which were further broken up, typically into quarter sections equal to 160 acres. A drag hose 54 at least 660 feet long reaches from the center of a quarter-section to the edges. This allows articulating tractor 12 to be positioned generally in the center of a quarter section field while tractor 84 of applicator drag hose system 82 is able to apply wastewater the entire length of the field in one pass. Covering the length of the field in one pass reduces puddling or pooling that may occur during turning because the number of turns required during application is reduced. The shorter length also reducing high tension caused by end-pulling long lengths of hose.

The use of drag hose system 10 may reduce the need for additional equipment to move and/or reposition a drag hose. As tractor 84 of applicator drag hose system 82 works across the field, drag hose 54 is generally pulled on the ground behind tractor 84. Applicator drag hose 54 may become undesirably positioned. For example, drag hose 54 may become rolled or kinked. Additionally or alternatively, it may be desirable to move drag hose 54 in order to change the curvature of the hose or reposition the hose with respect to tractor 84. Repositioning drag hose 54 may improve flow through the hose and/or may reduce the force required to pull the hose across the field. Repositioning drag hose 54 may also decrease the risk of internal damage caused by abrasive and/or sharp material flowing through tight curves or pinches. For example, wastewater may include rocks or sand. Repositioning the hose to increase the radius of curvature decreases the risk of the sharp and abrasive materials from contacting the inner surface of the hose and damaging the hose.

Previously, equipment was used to move and reposition drag hose. For example, a lift on the front or back of a tractor could be used to pick a drag hose up from the ground and reposition. Picking up and moving the drag hose increases the risk of abrasion to the hose. Burs or other defects in the surface of the handling equipment also present risks of damaging the hose.

Drag hose system 10 may reduce the need to pick up drag hose 52 and drag hose 54 because drag hose system 10 can move to reposition drag hoses 52 and 54. Further, the movements of articulating tractor 12 of drag hose system 10 and of tractor 84 of applicator drag hose system 82 can be coordinated to reduce rolling of drag hose 52 and drag hose 54 and to position drag hoses 52 and 54.

Tractor 12 of drag hose system 10 can provide a comfortable environment for an operator while supporting applicator drag hose system 82. Example support functions include but are not limited to monitoring tension or slack on drag hose 54, positioning drag hose 54 and drag hose 52, advancing drag hose 52 provide slack in drag hose 54 and enable applicator drag hose system 82 to reach the corners of a field or parcel of land, and assisting an operator of applicator drag hose system 82 such as by watching the rear of applicator drag hose system 82 during passage through a narrow portion or during a turn.

Drag hose system 10 having a two boom design may be used in other drag hose operations. For example, an applicator device may be connected, either rigidly or towed behind, to drag hose system 10, and drag hose system 10 may be operated as an applicator unit. In certain embodiments, drag hose system 10 may be positioned proximate to the liquid storage facility and may transfer wastewater from the storage facility to the line. For example, drag hose system 10 may be used as a pumping unit as described herein.

Although drag hose 54 is described as connected to top boom assembly 30 and drag hose 52 has been described as connected to bottom boom assembly 46, drag hose 52 and drag hose 54 can be switched so that drag hose 52 is connected to top boom assembly 30 and drag hose 54 is connected to bottom boom assembly 46.

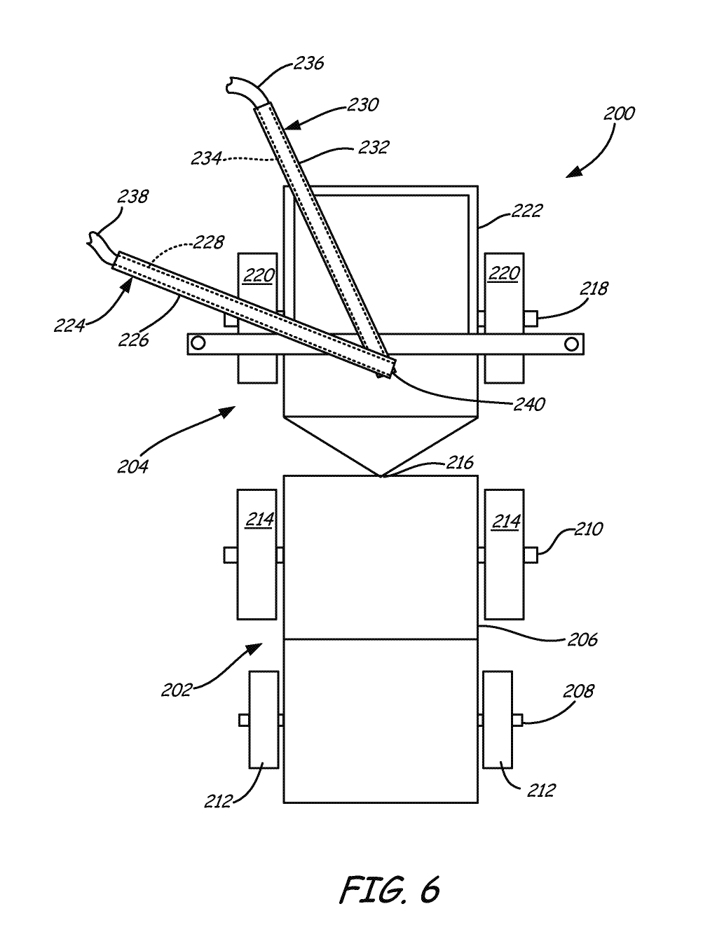

Additionally, the top boom assembly and the bottom boom assembly can be mounted on any stable platform. In FIG. 1-FIG. 5 above, the stable platform was the rear portion of an articulating tractor. FIG. 6 is a top view of drag hose system 200 in which the stable platform is a separate platform that is towed or drawn behind a tractor. Drag hose system 200 includes tractor 202 (having cab 206, front axle 208, rear axle 210, front tires 212, rear tires 214, and hitch 216), drawn platform 204 (having axle 218 and tires 220), frame 222, top boom assembly 224 (including top boom 226 and hose 228), and bottom boom assembly 230 (including bottom boom 232 and hose 234). Drag hose 236 connects to bottom boom 232, and drag hose 238 connects to top boom 226.

Tractor 202 can be any farm implement with sufficient towing capabilities to tow drawn platform 204. For example, tractor 202 can be an articulating or non-articulating style tractor. Tractor 202 can be a track style tractor in which rubber tires are replaced with a rubber track. A hitch or connection point, such as a three-point hitch or a drawbar, is located at the rear or aft end of tractor 202. Drawn platform 204 is connected to tractor 202 at hitch 206. Tractor 202 tows drawn platform 204 behind it.

Drawn platform 204 includes axle 218 and tires 220, which enable drawn platform to roll over the ground when drawn by tractor 202. Frame 222, top boom assembly 224, and bottom boom assembly 230 are mounted on drawn platform 204. Top boom assembly 224 and bottom boom assembly 230 can be substantially similar to top boom assembly 30 and bottom boom assembly 46 of FIGS. 1-5. Top boom assembly 224 and bottom boom assembly 230 are connected to and pivot about pivot point 240. Frame 222 supports top boom 226.

Drawn platform 204 must provide sufficient stability so as to support top boom assembly 224 and bottom boom assembly 230, particularly as drag hose 236 and drag hose 238 are pulled and as top boom 226 and bottom boom 232 pivot. Providing top boom assembly 224 and bottom boom assembly 230 on separate drawn platform 204 enables an articulating and non-articulating tractor to be used.

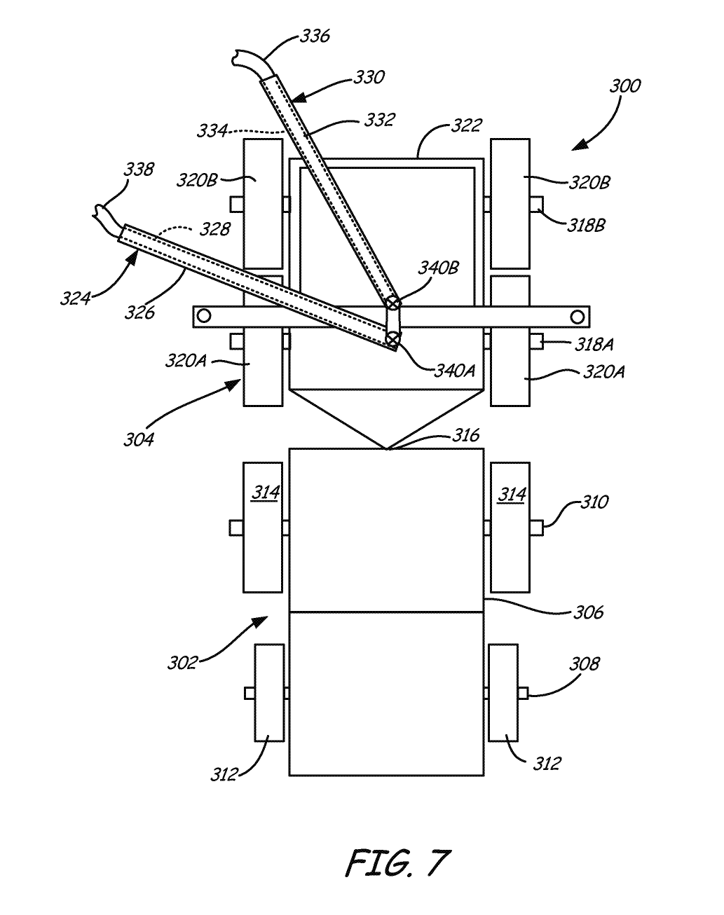

As discussed above, the top boom assembly and the bottom boom assembly can pivot about the same pivot point or pivot points having aligned vertical axes. Alternatively, as illustrated in FIG. 7, the boom assemblies can pivot about two pivot points in which the vertical axes are not aligned. FIG. 7 is a top view of a drag hose system 300 which includes tractor 302 (having cab 306, front axle 308, rear axle 310, front tires 312, rear tires 314, and hitch 316), drawn platform 304 (having front axle 318A, front tires 320A, rear axle 318B, and rear tires 320B), frame 322, top boom assembly 324 (including top boom 326 and hose 328), and bottom boom assembly 330 (including bottom boom 332 and hose 334). Drawn platform 304 is connected to tractor 302 by a hitch. Tractor 302 is similar to tractor 202 of FIG. 6. Additionally, drawn platform 304 is similar to drawn platform 204 except drawn platform 304 includes two pairs of axles (i.e., front axle 318A and rear axle 318B) to provide additional support and stability.

Top boom assembly 324 is similar to top boom assembly 224, and bottom boom assembly 330 is similar to bottom boom assembly 230. Top boom assembly 324 is connected to and pivots about first pivot point 340A. Bottom boom assembly 330 is connected to and pivots about second pivot point 340B. Top boom assembly 324 and bottom boom assembly 330 are connected to and pivot about different pivot points. The vertical axis extending through of pivot points 340A and 340B are not aligned. Pivot points 340A and 340B can be spaced apart vertically and horizontally. Connector 342 connects hose 334 of bottom boom assembly 330 to hose 328 of top boom assembly so that fluid flows from drag hose 336, through hose 334, connector 342, and hose 328 to drag hose 338.

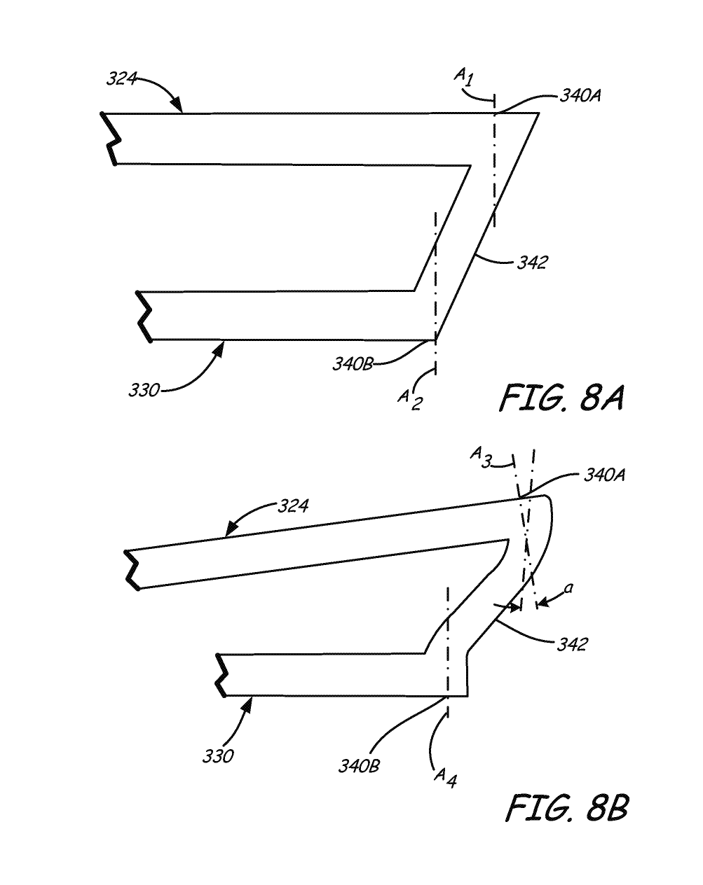

FIG. 8A is a side view of top boom assembly 324 and bottom boom assembly 330. In contrast to top boom assembly 224 and bottom boom assembly 230, in which the pivot points of top boom assembly 224 and bottom boom assembly 230 were along the same vertical axis, top boom assembly 324 and bottom pivot point 330 connect to pivots points 340A and 340B which are along different vertical axes. That is, axis A1 through the center of pivot point 340A does not align with axis A2 through pivot point 340B. Axis A1 and Axis A2 can be substantially vertical. That is, top boom assembly 324 can pivot about pivot point 340A about a substantially vertical axis along a substantially horizontal plane, and bottom boom assembly 330 can pivot about pivot point 340B about a substantially vertical axis along a substantially horizontal plane.

In an alternative embodiment, shown in the cross-sectional view of FIG. 8B, axis A3 of pivot point 340A is angled or pitched such that top boom assembly 324 pivots along a substantially non-horizontal plane. Axis A3 can form angle a with the vertical axis. In one example, angle a is between about 1 degree and about 30 degrees. In another example, angle a is between about 2 degrees and about 20 degrees. In a still further example, angle a is between about 3 degrees and about 15 degrees. Axis A4 of pivot point 340B pivots is not substantially angled from vertical (i.e., axis A4 is substantially vertical) and bottom boom assembly 330 pivots along a substantially horizontal plane. Alternatively, bottom boom assembly 330 can be pitched instead of or in addition to top boom assembly 324.

One skilled in the art will recognize that top boom assembly 324 and bottom boom assembly 330 may also be used on the rear portion of an articulating tractor, a non-articulating tractor or track style tractor, or on a stable platform that is fixed to a farm implement as described herein.

A method of manufacturing a drag hose system is also provided. The method include providing a platform, mounting a first boom to the platform at a first pivot point and mounting a second boom to the platform at the second pivot point. The platform can be attached to or may be configured to be attached to a farm implement, such as a tractor. For example, the platform can be rear portion 16 of articulating tractor 12 (see FIG. 1) or can be drawn platform 204, 304 of FIGS. 6 and 7. In some embodiments, the platform may include wheels. The first boom is configured to be connected to a first drag hose and the second boom is configured to be connected to a second drag hose.

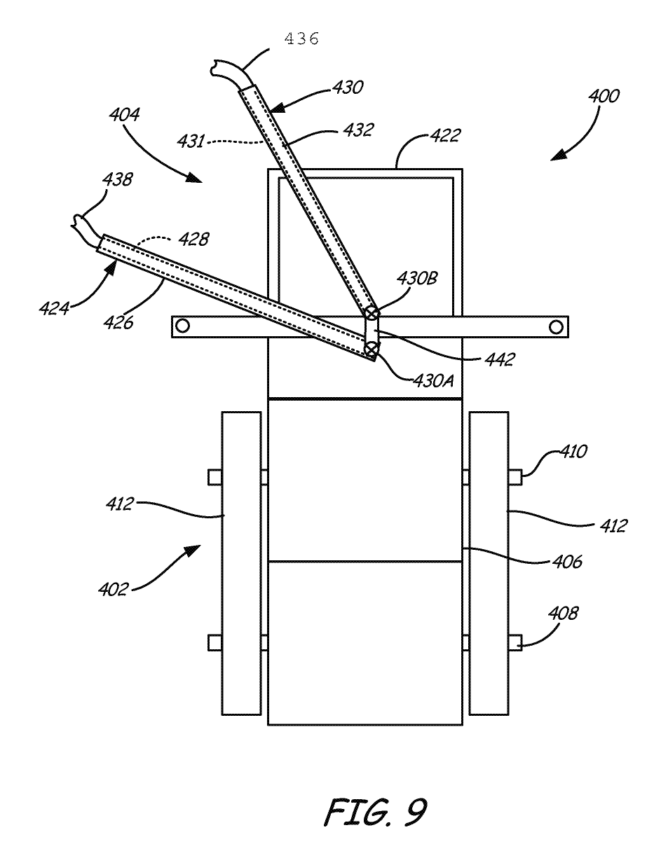

As described herein, a double boom system may be used in conjunction with a stable platform that is fixed to a farm implement. FIG. 9 is a top view of a drag hose system 400 which includes track tractor 402 (having cab 406, front axle 408, rear axle 410 and track 412), stable platform 404, frame 422, top boom assembly 424 (including top boom 426 and hose 428), and bottom boom assembly 430 (including bottom boom 432 and hose 434). Track tractor 402 runs on a continuous track instead of tires. Suitable track tractors include 9RT series tractors from John Deere. Track tractor 402 may provide zero turn characteristics.

Stable platform 404 is connected to or extends from tack tractor 402. For example, stable platform 404 may be rigidly mounted to track tractor 402. Stable platform 404 does not include wheels and cannot be moved independently of tractor 402. Rigidly mounting stable platform 404 to track tractor 402 may enhance maneuverability during turning. In an alternative embodiment, track tractor 402 may be replaced with any style tractor having sufficient power and handling capabilities. For example track tractor 402 may be replaced with a non-articulating tractor or an articulating tractor.

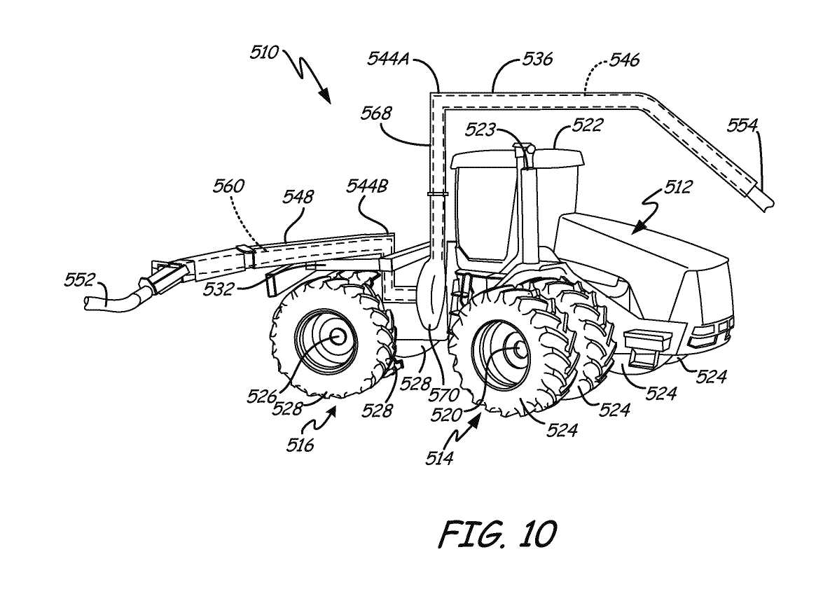

A further alternative embodiment is shown in FIG. 10 in which top boom 536 and bottom boom 548 are mounted on the back of articulating tractor 512. Top boom 536 is vertically positioned above bottom boom 548. Top boom 536 and bottom boom 548 are vertically spaced apart so that top boom 536 does not interfere with the movement of bottom boom 548. Support 568 connects top boom 536 and bottom boom 548.

Top boom 536 is elevated such that the bottom of top boom 536 is in a horizontal plane above the horizontal plane of the top of cab 522 and exhaust stack 523. Hose 560 extends through bottom boom 548 and is connected to hose 546, which extends through top boom 536. Hose 560 may be connected to hose 552 and hose 546 may be connected to hose 554 such that a flow path is formed from hose 552 through bottom boom 548 and top boom 536 to hose 554.

Top boom 536 can pivot along a substantially horizontal plane about pivot point 544A. That is, top boom 536 pivot about a vertical axis extending through pivot point 544A. Support 568 elevates top boom 536 such that the bottom of top boom 536 is above the top of cab 522. This enables top boom 536 and hose 554 to rotate 360° about pivot point 544A. Support 568 may be a tube or other hollow structure formed from a durable and solid material such as steel or other material. A hose extends through the center of support 568 and connects hose 560 of bottom boom 548 to hose 546 of top boom 536. Alternatively, support 568 may provide the structure and flow path without the use of a hose.

Support 568 is capable of supporting top boom 536 as it pivots or rotates. Elevating top boom 536 enables additional freedom of motion of hose 554. In use, top boom 536 and hose 554 may pass over cab 522 and in front of tractor 512. Other components in addition to 522 may vertically extend from tractor 512. For example, tractor 512 may include exhaust stack 523. As shown, top boom 536 passes over cab 522 and exhaust stack 523 and enables 360° of movement of top boom 536 about the vertical axis extending through pivot point 544A. In one example, top boom 536 can be roughly about 35 feet long to allow top boom 536 to clear the front of tractor 512. In another example, top boom 536 may extend at least about 15 feet past the front of tractor 512.

Bottom boom 548 may pivot about pivot point 544B. That is, bottom boom 548 may pivot about a vertical axis extending through pivot point 544B. As illustrated, bottom boom 548 can be mounted above rear wheel assemblies 528 of articulating tractor 512. This arrangement enables bottom boom 548 to rotate over rear wheel assemblies 528. Bottom boom 548 may be supported by frame 532 and stops (not shown) may be used to limit the rotation of bottom boom 548. For example, stops may be used to limit the motion of bottom boom 548 and hose 552 to prevent articulating tractor 512 from driving over hose 552 as described herein with respect to system 10.

Top boom 536 and bottom boom 548 rotate about pivot points 544A and 544B, respectively. As shown, pivot point 544A and 544B may not be vertically aligned. That is, the vertical axis extending through pivot point 544A may not aligned with the vertical axis extending through pivot point 544B as described herein.

Further top boom 536 and/or bottom boom 548 can be pitched or angled. For example, top boom 536 and bottom boom 548 may be pitched or angled such that the respective boom is biased to return to the center of rear portion 516 of articulating tractor 512 when there is little to no force on the boom.

Further, as described herein, top boom 536 and bottom boom 548 can have a segmented design. The segmented design enables the boom segments to rotate relative to each other and can prevent kinking of hoses 560 and 546. The segmented design may also reduce the risk of ripping the connection of hose 552 and hose 554 is the added degrees of freedom. Top boom 536 and bottom boom 548 may also include the knuckle described herein and/or may connect to hoses 552 and 554 by tow yokes.

Elevating top boom 536 such that top boom 536 may rotate 360° can enable less hose length to be required during use in the field. For example, enabling top boom 536 to rotate 360° means that hose 554 does not have to reach the length of tractor 512. Instead, top boom 536 may rotate to the front of tractor 512 when hose 554 is closer to the front of tractor 512 and top boom 536 may rotate to the back or rear of tractor 512 when hose 554 is closer to the rear of tractor 512.

Elevating top boom 536 such that top boom 536 may rotate 360° can improve maneuverability of tractor 512 to the left and to the right. In some embodiments, improvement maneuverability may be achieved when top boom 536 is capable of rotating 360°.

Pump 570 may be mounted on rear portion 516 of articulating tractor 512. For example, pump 570 may be connected to bottom boom 548 and top boom 536 such that a fluid flow path is formed through top boom 536, bottom boom 548 and pump 570. More specifically, pump 570 may be connected between top boom 536 and bottom boom 548. In one example, top boom 536 may connect the pump 570 by a swivel collar, which enables top boom 536 to pivot about pivot point 544A. In another example, bottom boom 548 may be connected to pump 570 by a swivel collar which enables bottom boom 548 to pivot about pivot 544B.

Pump 570 may be mounted on rear portion 516 of articulating tractor 512 forward of or in front of rear axle 526. That is, pump 570 may be closer to cab 522 then rear axle 526 is to cab 522. Alternatively, pump 570 may be mounted aft of rear axle 526.

Pump 570 is mobile and moves with tractor 512. No additional equipment is necessary to move pump 570 through the field. Additionally, no additional operators are necessary to move pump 570 through a field. By mounting pump 570 on tractor 512, pump 570 moves in coordination with drag hose system 510.

The placement of pump 570 on tractor 512 can simplify operation of drag hose system 510. For example, placement of pump 570 on tractor 512 may eliminate the need for operator to leave tractor 512 in order to adjust auxiliary equipment in the field. Pumping and application operations are continuously flow operations and it is desirable for tractor 512 to steadily advance over the field acres. It is also desirable to keep operators and personnel at key positions during the application process in order to achieve a smooth operation. As flow rates have increased, the need for an applicator operator to stay in tractor 512 during the entire application process has become more important. Further, as flow rates have increased, the need for personnel assisting with hose advancing activities to stay at key positions has become more important. In some situations, such personnel may not have time to leave their hose advancing activities in order to check auxiliary pumps in the field.

Adding pump 570 to tractor 512 can enable a single operator to handle hose advancing activities with top boom 536 and bottom boom 548 as well as maintenance or management of pump 570. In some situations, and operator may be required to operating pump 570, advance hose to an applicator unit, check line from storage to field. As flow rate increased, the timeframe to complete each of these activities has been further reduced. Adding pump 570 to tractor 512 reduces the time required for an operator to manage pump 570 along with the other activities described above.

As described herein hose 552 and 554 may have a diameter of at least about 6 inches, and in some embodiments may be at least about 8 inches. Previously, hoses with a smaller diameter than 6 inches were typically used in drag hose systems. It had been found, that larger lines (e.g. hoses having a diameter of 6 inches or greater) may have a greater tendency to fold or twist than smaller lines. Such twisting and folding may cause as much damage to the drag hose as the wear from being dragged over the soil and decreases the life of the hose. In some situations, increasing flows from 2000 gallons per minute to 2500 gallons per minute or even 2700 gallons per minute resulted in the drag hose maintaining its curve as it was pulled. As the flow rate through the hose is increased, the drag hose may experience less folding. One reason this may occur is that the sheer velocity of material moving through the drag hose may tend to straighten out the hose. The higher flow rate combined with a wider applicators reduces the number of trips required across the field to apply the same amount material. This combination also results in the drag hose forming larger loops from pass-to-pass because of the wider applicator width. These factors may result in an increased flow rate as described herein.

In order to extend the life of a drag hose, a wider applicator and increase flow rate may be used with system 510. For example, in some situations, hose 552 and 554 may have 6 inch diameters and may contain liquid provided at a flow rate of 3000 gallons per minute. Pump 570 increases the flow rates through the drag hose, providing an increased flow rate in hoses 552 and 554, and thus reducing wear on the hoses. Pump 570 can increase the pressure and hose 554. Pump 570 enables a single operator to stay with the unit much of the time. This reduces the time required for an operator to travel between different equipment locations or positions.

Pump 570 may be powered by tractor 512. In certain embodiments, pump 570 may be connected to the power takeoff unit of tractor 512. In other embodiments, pump 570 may be connected directly to the drive line shaft of tractor 512. Alternatively pump 570 may be powered with a separate power source, such as a generator or a separate engine.

One skilled in the art will recognize that top boom 536, bottom boom 548 and pump 570 may be used with a non-articulating tractor or with a track style tractor. For example top boom 536, bottom boom 548 and pump 570 may be mounted onto stable platform, such as the stable platform illustrated in FIG. 9, maybe towed behind a tractor on a wheeled platform such as shown in FIG. 6 or may be mounted directly to a non-articulating or a track style tractor as discussed herein.

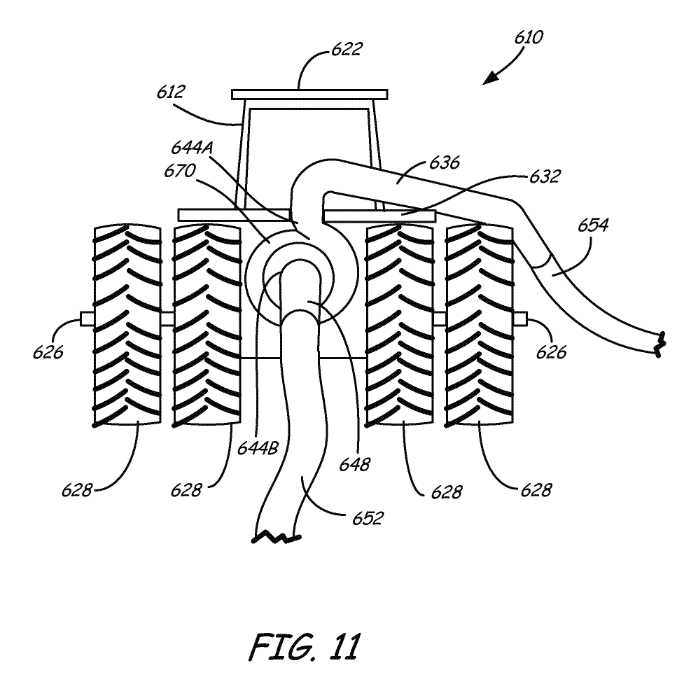

In an alternative embodiment, the stable platform may be the body of the farm implement. FIG. 11 is a rear perspective view of drag hose system 610 which includes tractor 612 (having rear wheel assemblies 628), support frame 632, top boom 636, bottom boom 648, hose 652, hose 654, and pump 670. Tractor 612 can be a non-articulating tractor, such as a tractor including tires or tracks. Pump 670 is mounted on tractor 612. For example, pump 670 may be mounted behind 622. In one example, pump 670 is mounted aft of rear axle 626 of rear wheel assemblies 628. In another example, pump 670 is mounted forward of rear axle 626 of rear wheel assemblies 628 (e.g., pump 670 is closer to cab 622 than rear axle 626 is to cab 622).

Top boom 636 and bottom boom 648 may have segmented designs as described herein. Top boom 636 pivots about pivot point 644A. Bottom boom 648 pivots about pivot point 644B. More specifically, top boom 636 may pivot along a substantially horizontal plane about the vertical axis through pivot 644A and bottom boom 648 may pivot along a substantially horizontal plane about the vertical axis through pivot 644B. The vertical axes through pivot points 644A and 644B may be aligned. Alternatively the vertical axes through pivot points 644A and 644B maybe horizontally spaced apart so that the vertical axis through pivot 644A does not align with the vertical axis through pivot 644B.

Pump 670 may be powered by tractor 612. In certain embodiments, pump 670 may be connected to the power takeoff unit of tractor 612. In other embodiments, pump 670 may be connected directly to the drive line shaft of tractor 612. Alternatively pump 670 may be powered by a separate power source, such as a generator or a separate engine.

Top boom 636 and bottom boom 648 are mounted on tractor 612 and are in fluid communication with pump 670. Top boom 636 is connected to hose 654 and bottom boom 648 is connected to hose 652. In use, fluid may flow through hose 652 to bottom boom 648 and then to pump 670. From pump 670, the fluid may flow through top boom 636 and then to hose 654. Alternatively, fluid may enter through hose 654 and leave system 610 through hose 652.

Top boom 636 and bottom boom 648 can pivot about pump 670. As described herein, pivoting enables top boom 636 and bottom boom 648 to improve application rates. Pump 670 increases the flow rate of liquid through top boom 636 and bottom boom 648. As discussed herein, top boom 636 and bottom boom 648 enable higher application rates in a lower amount time. Liquid must be provided to top boom 636 and bottom boom 648 at a higher rate to meet the demands of the increased application rates. For example, additional pump power may be required as flow rate increase from 1000 gallons per minute to 3000, or even 5000, gallons per minute.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the above described features.

The following is claimed:

1. A drag hose assembly comprising:
a first pivot point on a platform;
a first boom having a first end and a second end, the first end of the boom pivotally attached to the first pivot point so that the first boom can pivot about the first pivot point;
a second pivot point on the platform;
a second boom having a first end and a second end, the first end of the boom pivotally attached to the second pivot point so that the second boom can pivot about the second pivot point independent of the first boom; and
a fluid flow path extending through the first boom and the second boom, wherein the first boom is configured to attach to a first drag hose and the second boom is configured to attach to a second drag hose.

2. The drag hose assembly of claim 1, wherein the first boom can pivot at least about 10 degrees about the first pivot point and wherein the second boom can pivot at least about 10 degrees about the second pivot point.

3. The drag hose assembly of claim 1, wherein the first end of the second boom is closer to the ground than the first end of the first boom.

4. The drag hose assembly of claim 1, wherein the first boom can pivot along a substantially horizontal first plane about a first will vertical axis, the second boom can pivot along a substantially horizontal plane about a second vertical axis, and wherein the first plane and the second plane are substantially parallel.

5. The drag hose assembly of claim 1, wherein the first boom can pivot 360 degrees about the first pivot point.

6. The drag hose assembly of claim 1, wherein the first pivot point and the second pivot point are vertically spaced apart.

7. The drag hose assembly of claim 1, wherein the platform is a rear portion of an articulating tractor.

8. The drag hose assembly of claim 7, wherein the articulating tractor further includes an articulation point and a rear portion including a rear axle, and wherein the first pivot point is located between the articulation point and the rear axle.

9. The drag hose assembly of claim 1, wherein the platform is a stable platform connected to or is configured to be connected to a farm implement.

10. The drag hose assembly of claim 1, wherein the platform includes wheels and is configured to be towed by a farm implement.

11. The drag hose assembly of claim 1, wherein the second boom includes a plurality of boom segments connected to one another to permit limited vertical and horizontal movement of the boom segments.

12. The drag hose assembly of claim 1, and further comprising a pump on the platform, the pump connected to the fluid flow path between the first boom and the second boom.

13. A method of manufacturing a drag hose system, the method comprising:
mounting a first boom to a platform at a first pivot point, wherein the first boom is configured to be connected to a first drag hose, and wherein the platform is attached to or is configured to be attached to a farm implement; and
mounting a second boom to the platform at a second pivot point, wherein the second boom is configured to be connected to a second drag hose.

14. The method of claim 13, wherein the platform is a rear portion of an articulating tractor.

15. The method of claim 13, wherein the platform is configured to be towed behind a farm impliment.

16. The method of claim 13, wherein the first pivot point and the second pivot point are along a same vertical axis.

17. The method of claim 13, wherein a vertical axis of the first pivot point does not align with a vertical axis of the second pivot point.

18. The method of claim 13, wherein the first boom assembly pivots about the first pivot point along a substantially non-horizontal plane and the second boom assembly pivots about the second pivot point along a substantially horizontal plane.

19. The method of claim 13, and further comprising:
mounting a pump to the platform; and
connecting the pump between the first boom and the second boom.

20. The method of claim 13, wherein the first boom can pivot 360 degrees.
